(19) United States
(12) Patent Application Publication
(10) Pub. No.: US 2005/0276436 A1
(43) Pub. Date: Dec. 15, 2005

(54) Speaker device

(76) Inventors: Hiroyuki Kobayashi, Yamagata (JP); Kenichi Kasahara, Yamagata (JP); Shinichi Hayasaka, Yamagata (JP); Toshihiro Hikichi, Yamagata (JP)

Correspondence Address: YOUNG & THOMPSON, 745 SOUTH 23RD STREET, 2ND FLOOR, ARLINGTON, VA, 22202, US

(21) Appl. No.: 11/085,142

(22) Filed: Mar. 22, 2005

(30) Foreign Application Priority Data
Mar. 25, 2004 (JP) 2004-89334

(51) Int. Cl. H04R 25/00

(52) U.S. Cl. 381/409; 381/182; 381/391

(57) ABSTRACT

A speaker device includes speaker units for reproducing high- and low-frequency sound, a frame having a guide structure formed thereat, a relay wire drawn from a voice coil in the speaker unit for reproducing high-frequency sound, a relay wire for the speaker unit for reproducing low-frequency sound, and a terminal unit electrically connected to the side of an amplifier. Each of the relay wires is electrically connected to the terminal unit via the guide structure. An electric signal is input into the speaker units for reproducing high- and low-frequency sound from the side of the amplifier. The guide structure has a wall standing on a center axis side of the speaker device to restrict the movement of the relay wires, even if variations occur thereby preventing the relay wires from being loosened or expanded from the position of the wall toward the center axis side of the speaker device.

### TECHNICAL FIELD

This invention relates to a coaxial type speaker.

### BACKGROUND ART

Conventionally, as a speaker capable of achieving the reproduction of a flat sound from a low frequency band to a high frequency band, there is known a coaxial type speaker including a speaker unit for reproducing high-frequency sound (a so-called tweeter) and a speaker unit for reproducing low-frequency sound (a so-called woofer), for example. In one example of such a coaxial type speaker, a tweeter and a woofer are arranged on the same axis, and the tweeter is disposed at an upper position on a sound output side of the woofer. Moreover, in the above-described coaxial type speaker, a terminal unit is provided in the vicinity of an outer peripheral wall of a woofer frame which covers a magnetic circuit of the woofer. Tinsel wires connected to a voice coil in the woofer, a relay wire connected to one of the tinsel wires, another relay wire drawn from a voice coil in the tweeter and a wire drawn from an amplifier are connected to the terminal unit. In this manner, electric signals are input into the tweeter and the woofer from the amplifier via the terminal unit.

Incidentally, as the speaker of this type, there is known, for example, a coaxial speaker in which a speaker for high-frequency sound is supported by a bridge type supporter bridged from a frame peripheral edge of a speaker for low-frequency sound in front of the speaker for low-frequency sound (see. for example, Japanese Patent Application Laid-Open under No. 10-341491) and a coaxial type speaker in which a second speaker having a diameter smaller than that of a first speaker is disposed in front of the first speaker in such a manner that orientation can be varied (see. for example, Patent Application Laid-Open under No. 10-308993).

In the coaxial type speaker as described above, the relay wire may be loosened or expanded toward the coaxial type speaker according to a method for guiding the relay wire of the tweeter and the woofer. This has raised a problem that the loosened or expanded relay wire interferes with (or hits against) a constituent element in the woofer such as a tinsel wire or a diaphragm when the coaxial type speaker is driven. Therefore, it has been necessary to take the process of preventing any interference of the relay wire at the time of manufacturing the speaker in order to avoid such an inconvenience.

### DISCLOSURE OF THE INVENTION

As problems to be solved by the invention, above-described problems are exemplified. An object of the invention is to provide a speaker device capable of preventing any interference (namely, hitting) between a relay wire of a speaker unit for reproducing high-frequency sound or the like and a constituent element of a speaker unit for reproducing low-frequency sound, when the speaker is driven.

In a preferred embodiment according to the invention, a speaker device includes: a speaker unit; a wire drawn from a voice coil of the speaker unit; and a guide structure for guiding the wire, wherein the guide structure includes a wall standing on a side of the speaker unit, and wherein the wire is guided along the wall on a side opposite to the speaker unit.

The above-described speaker device includes a speaker unit, for example, a speaker unit for reproducing high-frequency sound. The speaker unit may be a speaker unit for reproducing low-frequency sound. The wire drawn from the voice coil of the speaker unit for reproducing high-frequency sound is guided toward a terminal unit electrically connected to a side of an amplifier by the guide structure, and is electrically connected to the terminal unit. The guide structure includes the wall standing on a side of the speaker unit for reproducing high-frequency sound, and the wire is guided along the wall on a side opposite to the speaker unit. Consequently, even if variations occur in the styling of the wire by the guide structure, the movement of the wire toward the speaker unit can be restricted by the wall, so that the wire cannot be loosened or expanded toward a center axis side of the speaker device from the position of the wall. In this way, it is possible to effectively prevent any interference (namely, any hitting) between the wire and a constituent element of the speaker device when the speaker device is driven. Thus, it is possible to omit work for styling the wire by the guide structure or the like during fabrication of the speaker device, and is possible to easily and stably arrange the wire.

In one mode, the speaker device further includes: another speaker unit; and a grille disposed on a sound output side of the other speaker unit, wherein the speaker unit is arranged coaxially with and above the other speaker unit, and wherein the speaker unit is fixed to the grille in a state in which a sound output side of the speaker unit faces the sound output side of the other speaker unit.

According to the above mode, the other speaker unit may be a speaker unit for reproducing low-frequency sound. The speaker unit, for example, the speaker unit for reproducing high-frequency sound is arranged coaxially with and above the speaker unit for reproducing low-frequency sound. Consequently, a coaxial type speaker device can be configured to achieve the reproduction of a flat sound from a low frequency band to a high frequency band.

Particularly, in the above-described coaxial type speaker device, the speaker unit for reproducing high-frequency sound is fixed to the grille in a state in which the sound output side of the speaker unit for reproducing high-frequency sound opposes to the sound output side of the speaker unit for reproducing low-frequency sound. As a consequence, an acoustic wave radiated from the speaker unit for reproducing high-frequency sound is reflected by the grille surface, and then is radiated in a radial manner in the same direction as a sound output direction of the speaker unit for reproducing low-frequency sound.

In a preferred example, the guide structure may be formed at a frame of the other speaker unit (for example, the speaker unit for reproducing low-frequency sound) disposed under the speaker unit (for example, the speaker unit for reproducing high-frequency sound). Preferably, the wire is guided between an outer peripheral wall of the frame and the wall. Furthermore, the guide structure may be formed at the frame simultaneously with the fabrication of the frame. Consequently, it is possible to prevent any increase in product cost of the frame. Moreover, it is preferable to make the frame of a resin material in order to reduce the weight of the speaker device.

In another mode of the above-described speaker device, the frame includes a flange portion which is fitted to a peripheral edge of the grille, and wherein the flange portion includes: a through hole into which the wire drawn from the voice coil side is inserted; a recess which communicates with the through hole and guides the wire inserted into the through hole toward the guide structure; and an opening which communicates with the recess and the guide structure and guides the wire guided by the recess to the guide structure.

According to the above-described mode, the wire drawn from the voice coil of the speaker unit, for example, the speaker unit for reproducing high-frequency sound can be guided toward the guide structure through the through hole, the recess and the opening. Consequently, the wire can be guided toward the guide structure side with a shortest distance as possible.

In a still another mode of the above-described speaker device, a terminal unit is arranged between the guide structure and an upper end on an outer peripheral wall of the frame, and wherein the guide structure is formed from the vicinity of an inner circumferential edge of the flange portion to the terminal unit. As a consequence, the wire drawn from the voice coil in the speaker unit, for example, the speaker unit for reproducing high-frequency sound can be guided toward the terminal unit electrically connected to the side of the amplifier, by the guide structure. In this manner, the wire may be electrically connected to the terminal unit. Thus, an electric signal output from the amplifier may be input into the speaker unit for reproducing high-frequency sound.

In a still another mode of the above-described speaker device, a slit portion is formed from an upper portion of the guide structure to a lower portion of the guide structure, and a space to receive the wire is defined between the slit portion and the wall.

According to this mode, since the guide structure includes the space between the slit portion and the wall, the wire may be arranged within the space. Furthermore, the guide structure includes the slit portion, and hence the wire drawn from the voice coil of the speaker unit, for example, the speaker unit for reproducing high-frequency sound may be guided along the guide structure, from the upper portion of the guide structure to the lower portion of the guide structure.

### BRIEF DESCRIPTION OF THE DRAWING

FIG. 1 is a cross-sectional view showing the configuration of a speaker device according to a preferred embodiment of the invention;

FIG. 2 is a side view showing a frame according to the embodiment;

FIG. 3 is a back view showing the frame according to the embodiment;

FIGS. 4A and 4B are a perspective view and the like showing the vicinity of a guide structure in the frame according to the embodiment; and

FIG. 5 is a diagram schematically illustrating the arrangement of an electric circuit in the speaker device according to the embodiment.

### BEST MODE FOR CARRYING OUT THE INVENTION

A description will be given below of a preferred embodiment according to the invention with reference to the attached drawings. The present embodiment is directed to a guide structure and the like in a speaker device. Particularly, this embodiment adopts a structure capable of preventing any interference (namely, any hitting) between a relay wire of a tweeter and a constituent element of a woofer when the speaker device is driven.

[Configuration of Speaker Device]

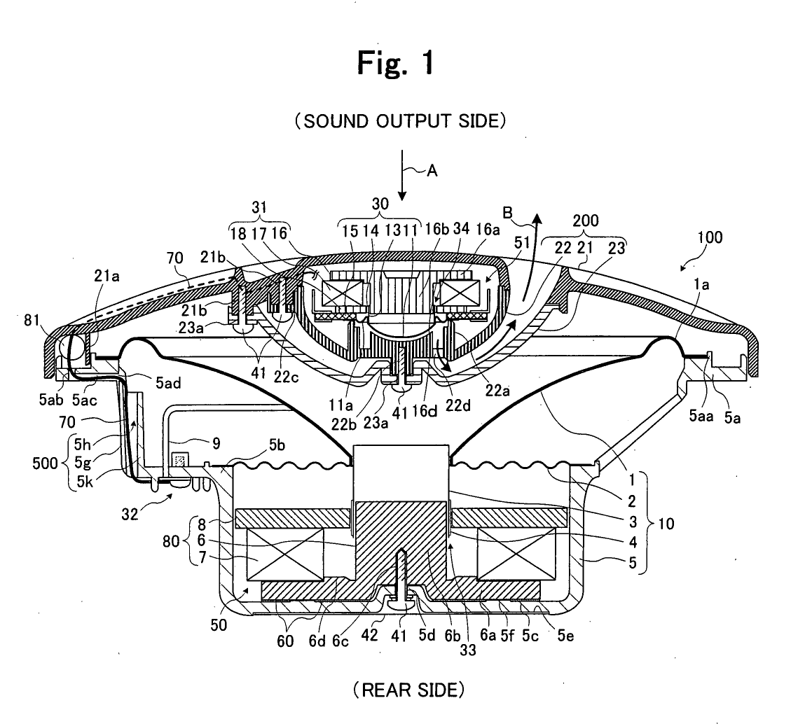

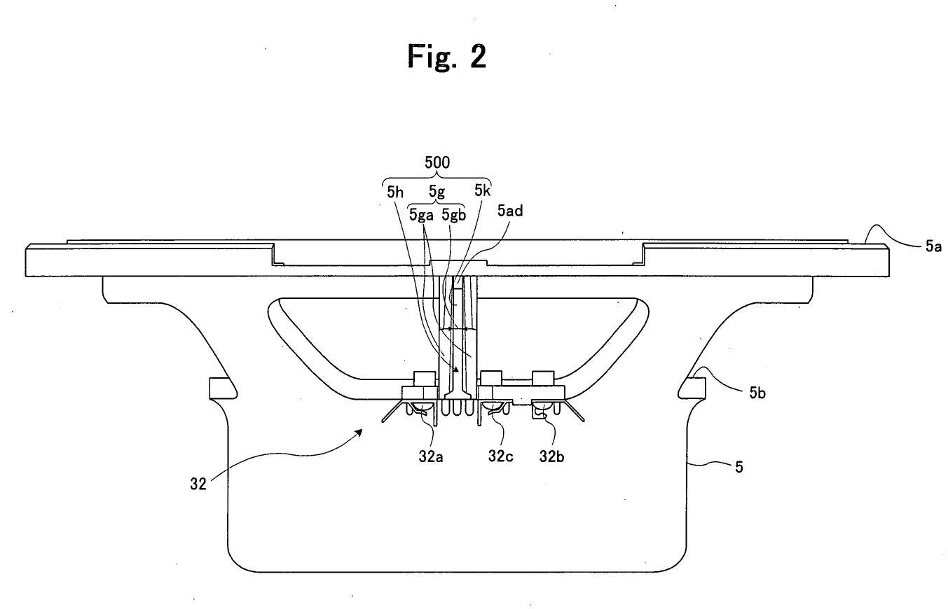

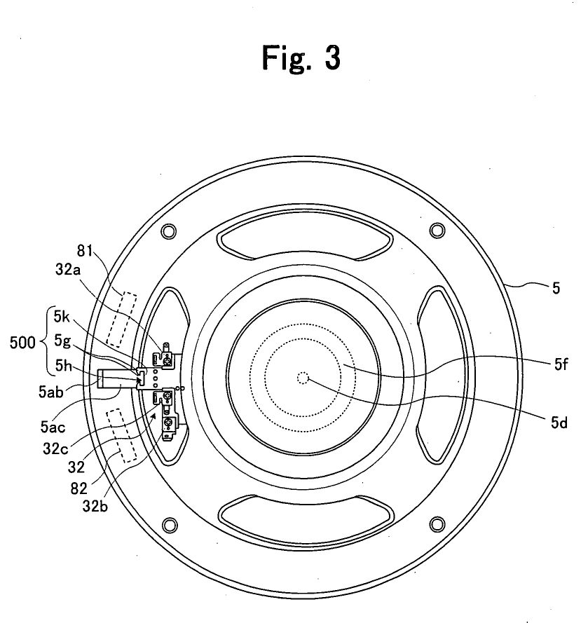

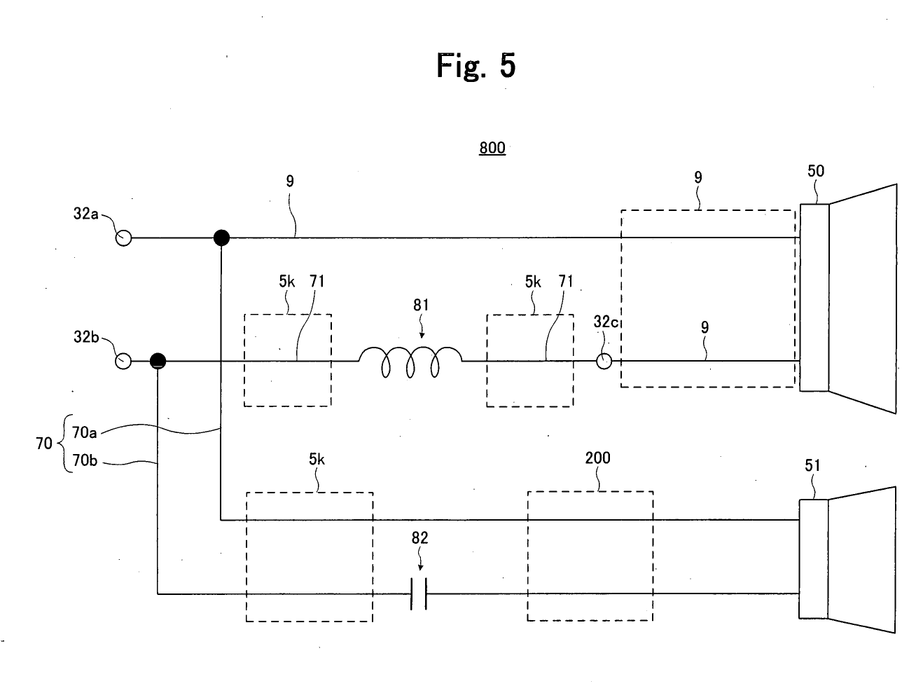

First, FIG. 1 is a view schematically showing the general configuration of a speaker device 100 according to a preferred embodiment of the invention. FIG. 1 is a cross-sectional view cut by a plane including a center axis of the speaker device 100. Here, the speaker device 100 in this embodiment can be suitably used as a speaker to be mounted on a vehicle. FIG. 2 is a side view of a frame 5, and FIG. 3 is a back view of the frame 5. FIG. 5 is a diagram schematically illustrating the arrangement of an electric circuit 800 of the speaker device 100. Hereinafter, the configuration of the speaker device 100 and the like in this embodiment will be described with reference to FIGS. 1 to 3 and 5.

The speaker device 100 is provided with a speaker unit 50 for reproducing low-frequency sound, a speaker unit 51 for reproducing high-frequency sound and other various members. The speaker device 100 is a so-called coaxial type two-way speaker, in which the speaker unit 51 for reproducing high-frequency sound placed on a sound output side and the speaker unit 50 for reproducing low-frequency sound placed on a rear side are arranged coaxially with each other. Furthermore, in the above-described speaker device 100, the speaker unit 51 for reproducing high-frequency sound is disposed inside of a grille in such a manner that the sound output side of the speaker unit 51 for reproducing high-frequency sound faces the sound output side of the speaker unit 50 for reproducing low-frequency sound, as illustrated. Particularly, an acoustic wave radiated from the speaker unit 51 for reproducing high-frequency sound is radiated in a radial manner, along a direction indicated by an arrow B, in the same direction as a sound output direction of the speaker unit 50 for reproducing low-frequency sound. In this manner, the speaker device 100 can reproduce a flat sound from a low-frequency band to a high-frequency band. Here, the speaker unit 50 for reproducing low-frequency sound may be a speaker unit capable of reproducing low and middle frequency sounds. Alternatively, the speaker unit 51 for reproducing high-frequency sound may be a speaker unit capable of reproducing high and middle frequency sounds.

First of all, a description will be given of the configuration of the speaker unit 50 for reproducing low-frequency sound. The speaker unit 50 for reproducing low-frequency sound mainly includes a vibrating system 10 having a diaphragm 1, a damper 2, a voice coil bobbin 3, a voice coil 4 and the frame 5, and a magnetic circuit system 80 having a pole piece 6, an annular magnet 7 and an annular plate 8.

First, explanation will be made on each of the constituent elements in the vibrating system 10.

The diaphragm 1 is a so-called conical diaphragm, which is adhesively joined to a separate edge la or is formed integrally with an edge 1a. The diaphragm 1 may be made of various kinds of materials such as paper-based, high polymer-based and metal-based materials according to various applications. An outer peripheral edge of the edge 1a is securely attached onto a first flange portion 5a disposed at an upper end of the frame 5. On the other hand, an inner circumferential edge of the diaphragm 1 is securely attached to the vicinity of an upper end on an outer peripheral wall of the voice coil bobbin 3.

The damper 2 is made of a fabric material impregnated with a thermosetting resin such as a phenol resin, and a plurality of corrugations are formed in a concentric manner. The damper 2 supports the voice coil bobbin 3. An inner circumferential edge of the damper 2 is securely attached to the vicinity of the upper end on the outer peripheral wall of the voice coil bobbin 3. On the other hand, an outer peripheral edge of the damper 2 is securely attached onto a second flange portion 5b disposed at an upper end on an outer peripheral wall of the frame 5.

The voice coil bobbin 3 is formed into a substantially cylindrical shape. The voice coil 4 is wound around the voice coil bobbin 3 in the vicinity of a lower end on an outer peripheral wall thereof. In addition, the vicinity of the lower end on the outer peripheral wall of the voice coil bobbin 3 faces an inner circumferential wall of the annular plate 8 with a predetermined spacing. On the other hand, the vicinity of a lower end on an inner circumferential wall of the voice coil bobbin 3 faces the vicinity of an upper end on an outer peripheral wall of the pole piece 6 with a predetermined spacing. A gap (namely, a magnetic gap 33) is defined between the vicinity of the upper end on the outer peripheral wall of the pole piece 6 and a corresponding inner circumferential wall of the plate 8.

The voice coil 4 has positive/negative lead terminals (not shown). A lead terminal on a positive side serves as an input terminal for an L (or R) channel signal, and a lead terminal on a negative side serves as an input terminal for a ground (GND: earth) signal. Each of the lead terminals is electrically connected to one end of each of tinsel wires 9 at a predetermined position of the diaphragm 1. The other end of each of the tinsel wires 9 is electrically connected to a side of the terminal unit 32.

Specifically, as illustrated in FIG. 5, the other end of one of the tinsel wires 9 is electrically connected to a first terminal 32a. The other end of the other tinsel wire 9 is electrically connected to a third terminal 32c. A relay wire 71 connected to the third terminal 32c is drawn along a wall 5k of a guide structure 500 and is connected to one end of a coil 81, as described later. Another relay wire 71 connected to the other end of the coil 81 is drawn along another wall 5k and is electrically connected to a second terminal 32b. As a consequence, an electric signal of one channel is input into the voice coil 4 from an amplifier, not illustrated.

Various constituent parts in the speaker device 100 are fixed to the frame 5, and the frame 5 has the function of supporting the speaker device 100. The frame 5 may be made of various materials and, more preferably be made of a resin material for the purpose of weight reduction. The frame 5 includes the first flange portion 5a, the guide structure 500, the second flange portion 5b, the terminal unit 32 and a mounting portion 5c on which the magnetic circuit system 80 is mounted.

The first flange portion 5a is formed in a flange shape at the upper end of the frame 5. The first flange portion 5a includes an annular projection 5aa, a through hole 5ab, a recess 5ac and an opening 5ad. According to these constituent elements, a relay wire 70 described later can be guided toward the guide structure 500 with a shortest distance as possible.

The annular projection 5aa annularly projects toward a grille 200 described later. The annular projection 5aa engages with an annular projecting strip 21a formed at the grille 200 and has the function of supporting the grille 200. The through hole 5ab is formed into a substantially rectangular shape in such a manner as to penetrate from an upper surface of the first flange portion 5a to a lower surface thereof, and is formed at a position in the vicinity of an upper end of the guide structure 500. The relay wire 70 drawn along a back surface of the grille 200 from a voice coil 14 of the speaker unit 51 for reproducing high-frequency sound is inserted in the through hole 5ab, so that the relay wire 70 is guided toward the recess 5ac. The recess 5ac is depressed in a rectangular shape, and is formed at a position at a lower surface of the first flange portion 5a and between the through hole 5ab and the opening 5ad. The recess 5ac communicates with the through hole 5ab, and the recess 5ac guides the relay wire 70 inserted into the through hole 5ab toward the opening 5ad. The opening 5ad is formed into a rectangular shape and provided between the recess 5ac and the upper end of the guide structure 500. The opening 5ad communicates with each of the recess 5ac and a space 5h defined in the guide structure 500. The opening 5ad has the function of guiding the relay wire 70, which is guided through the through hole 5ab and the recess 5ac, toward the space 5h defined in the guide structure 500.

The guide structure 500 has the functions of guiding the relay wire 70, which is drawn from a side of the voice coil 14 in the speaker unit 51 for reproducing high-frequency sound, toward the terminal unit 32 via the first flange portion 5a, and of guiding the pair of relay wires 71 connected to both ends of the coil 81. The guide structure 500 features the invention, and therefore detailed descriptions will be given later of its structure, functions, effects and the like.

The second flange portion 5b is formed into a flange shape at an upper end on an outer peripheral wall of the frame 5. To the second flange portion 5b, an outer peripheral edge of the damper 2 is securely fixed. The second flange portion 5b supports the damper 2.

The terminal unit 32 includes the first terminal 32a, the second terminal 32b and the third terminal 32c, and is formed from a lower end of the guide structure 500 to the second flange portion 5b. Here, the first terminal 32a, the second terminal 32b and the third terminal 32c are electrically insulated from each other. To the first terminal 32a and the second terminal 32b, a wire drawn from the amplifier side are connected. Consequently, an input signal from the amplifier side is applied to each of the first terminal 32a and the second terminal 32b. In addition, the tinsel wire 9 and a relay wire 70a are connected to the first terminal 32a. The relay wire 71 and another relay wire 70b are connected to the second terminal 32b. The tinsel wire 9 and the relay wire 71 are connected to the third terminal 32c.

The mounting portion 5c is formed at a lower portion of the frame 5. A truncated recess is formed on a center axis at a lower surface side of the mounting portion 5c. The mounting portion 5c includes an opening 5d, an annular projection 5f and a circular recess 5e. The opening 5d is formed on the center axis of the mounting portion 5c. The opening 5d is adapted to allow a fixing member 41, described later, to be inserted there into. The projection 5f is formed into an annular shape in the vicinity of a peripheral edge on the mounting portion 5c. The projection 5f has the function of stably fixing the magnetic circuit system 80 without any inclination in spite of variations in inclination of the upper surface of the mounting portion 5c or deformation of the mounting portion 5c caused by excessive fastening of the fixing member 41. The recess 5e is formed at the lower surface of the mounting portion 5c, and a name plate 42, described later, is stuck to the recess 5e.

Subsequently, explanation will be made on constituent elements in the magnetic circuit system 80.

The magnetic circuit system 80 is configured as a magnetic circuit of an external magnet type. The magnetic circuit includes the pole piece 6, the annular magnet 7 and the annular plate 8.

The pole piece 6 is formed into a substantially inverted T shape, as viewed in cross section. The pole piece 6 is securely mounted onto the mounting portion 5c of the frame 5 via an adhesive agent 60. The pole piece 6 includes a yoke 6a formed into a flange shape and a center pole 6b formed into a columnar shape.

The yoke 6a is interposed between the mounting portion 5c of the frame 5 and the magnet 7. A step portion 6d formed into a stepped shape is formed in the vicinity of an inner circumferential edge on the yoke 6a. The magnet 7 is positioned at a proper position on the yoke 6a in a state in which a part of an inner circumferential edge of the annular magnet 7 abuts against the step portion 6d.

The center pole 6b is erected on the center axis of the mounting portion 5c. A truncated recess is formed on the center axis at a lower surface of the center pole 6b. A fixing hole 6c (for example, a female screw), which is fitted to the fixing member 41 (for example, a male screw), is formed on the center axis of the recess. The fixing member 41 is inserted into the fixing hole 6c, and is fixed by screw joint or the like.

The annular magnet 7 is disposed in such a manner as to overlap the upper surface of the yoke 6a, and further the annular plate 8 is disposed in such a manner as to overlap the upper surface of the magnet 7.

In the magnetic circuit system 80, the magnet 7, the plate 8 and the pole piece 6 constitute the magnetic circuit. Amagnetic flux of the magnet 7 is concentrated on the magnetic gap 33 defined between the inner circumferential wall of the plate 8 and the outer peripheral wall of the center pole 6b.

Next, a description will be given of the configuration of the speaker unit 51 for reproducing high-frequency sound. The speaker unit 51 for reproducing high-frequency sound mainly includes a vibrating system 30 having a diaphragm 11, a voice coil bobbin 13, the voice coil 14 and a frame 15, and a magnetic circuit system 31 having a pole piece 16, an annular magnet 17 and an annular plate 18. For the convenience' sake, explanation will be made below on the configuration of the speaker unit 51 for reproducing high-frequency sound in order as observed in a direction indicated by an arrow A.

First, explanation will be made on each of the constituent elements in the vibrating system 30.

The diaphragm 11 is a so-called dome-shaped diaphragm, around which an edge 11a constituted independently of the diaphragm 11 is attached. The diaphragm 11 may be formed integrally with the edge 11a. Like the above-described diaphragm 1, the diaphragm 11 may be made of various kinds of materials such as paper-based, high polymer-based and metal-based materials according to the various applications. An outer peripheral edge of the edge 11a is securely mounted on the frame 15.

The frame 15 is made of, for example, a resin material, and is formed into a substantially annular shape. The frame 15 is interposed between the edge 11a and the plate 18, thereby supporting the diaphragm 11.

The voice coil bobbin 13 is formed into a substantially cylindrical shape. The voice coil 14 is wound around the upper end on the outer peripheral wall of the voice coil bobbin 13. The upper end on the outer peripheral wall of the voice coil bobbin 13 faces an inner circumferential wall of the annular plate 18 with a predetermined clearance. On the other hand, the upper end on the inner circumferential wall of the voice coil bobbin 13 faces the upper end on the outer peripheral wall of the pole piece 16 with a predetermined clearance. A gap (namely, a magnetic gap 34) is defined between the outer peripheral wall of the pole piece 16 and an inner circumferential wall of the plate 18.

The voice coil 14 is connected to one end of each of the positive/negative relay wires 70. The relay wire 70 on a positive side serves as an input wire for an L (or R) channel signal. The relay wire 70 on a negative side serves as an input wire for a ground (GND: earth) signal. Each of the relay wires 70 drawn from the voice coil 14 is electrically connected to the terminal unit 32.

Specifically, as is understood with reference to FIGS. 1 to 5, one relay wire 70a connected to the voice coil 14 is drawn along the back surface of the grille 200, the wall 5k of the guide structure 500 and the like, and then is electrically connected to the first terminal 32a. On the other hand, the other relay wire 70b connected to the voice coil 14 is drawn along the back surface of the grille 200, and then is electrically connected to one end of a capacitor 82. Furthermore, the other relay wire 70b connected to the other end of the capacitor 82 is drawn along the wall 5k of the guide structure 500 and the like, and then is electrically connected to the second terminal 32b. As a consequence, an electric signal of one channel is input into the voice coil 14 from the amplifier, not illustrated.

Subsequently, explanation will be made on constituent elements in the magnetic circuit system 31.

The magnetic circuit system 31 is configured as a magnetic circuit system of an external magnet type. The magnetic circuit includes the pole piece 16, the annular magnet 17 and the annular plate 18.

The pole piece 16 is formed into a substantially inverted T shape, as viewed in cross section. The pole piece 16 includes a yoke 16a having a flange shape and a center pole 16b having a columnar shape.

The yoke 16a is interposed between a first member 21 of the grille 200 and the magnet 17. A step portion 16d having a stepped shape is formed in the vicinity of an inner circumferential edge on the yoke 16a.

The annular magnet 17 is disposed so as to overlap the upper surface of the yoke 16a. A part of an inner circumferential edge of the annular magnet 17 abuts against an outer peripheral wall of the step portion 16d. In this manner, the magnet 17 is positioned at a proper position on the yoke 16a. Furthermore, the annular plate 18 is disposed to overlap the upper surface of the magnet 17.

In the magnetic circuit system 31, the magnet 17, the plate 18 and the pole piece 16 constitute the magnetic circuit. A magnetic flux of the magnet 17 is concentrated on the magnetic gap 34 defined between the inner circumferential wall of the plate 18 and the outer peripheral wall of the pole piece 16.

The speaker unit 51 for reproducing high-frequency sound having the above-described configuration is securely fixed inside of the grille 200 in such a manner that its sound output side opposes to the sound output side of the speaker unit 50 for reproducing low-frequency sound, as illustrated. Specifically, the speaker unit 51 for reproducing high-frequency sound is fixed inside of the grille 200 by fitting a plurality of fixing members to a plurality of fixing holes formed at the plate 18.

Other various members in the speaker device 100 include the fixing member 41, the grille 200, the name plate 42, the coil 81 and the capacitor 82.

It is preferable to use, for example, a male screw or a bolt as the fixing member 41. A male screw is formed at the tip of the fixing member 41. The fixing member 41 is fitted into each of fixing holes 21b formed at the first member 21, a fixing hole 22b formed at a second member 22, the fixing hole 6c formed at the pole piece 6 and the like. As a consequence, the first member 21, the second member 22 and a third member 23 are combined, and further the magnetic circuit system 80 is securely mounted on the mounting portion 5c of the frame 5.

The grille 200 can be made of various materials, and preferably, it is made of a resin material for the purpose of achievement of weight reduction. The grille 200 includes therein the speaker unit 51 for reproducing high-frequency sound, and further covers the speaker unit 50 for reproducing low-frequency sound on its sound output side. Therefore, the grille 200 mainly has the function of protecting the speaker unit 50 for reproducing low-frequency sound and the speaker unit 51 for reproducing high-frequency sound. Stripe-like clearances not shown are intermittently formed at the upper surface of the grille 200. Consequently, the speaker unit 50 for reproducing low-frequency sound radiates an acoustic wave toward the sound output side through the clearances.

The grille 200 includes the first member 21, the second member 22 and the third member 23.

The annular projecting member 21a, which has an intermittently annular shape and projects toward the first flange portion 5a of the flame 5, is formed in the vicinity of an outer peripheral edge at a lower surface of the first member 21. The annular projecting member 21a is fitted to the annular projection 5aa. Therefore, the grille 200 can be detachably attached to the flame 5 by fitting the outer peripheral edge of the first member 21 to the outer peripheral edge of the flame 5 while the annular projecting member 21a is fitted to the annular projection 5aa. Alternatively, a guide pin (not shown) projecting downward from the annular projecting member 21a may be fitted into a hole (not shown) formed at the outer periphery of the frame 5 in order to mount the first member 21 to the flame 5 with a predetermined clearance. Furthermore, the plurality of fixing holes 21b, to which the fixing members 41 are fitted, are formed at the lower surface of the first member 21. The fixing member 41 is fitted to each of the fixing holes 21b so as to fix the fixing member 41.

The second member 22 is formed into a substantially cup-like shape, as viewed in cross section. The second member 22 is arranged at a central position of the grille 200 and is interposed between the first member 21 and the third member 23. The second member 22 includes an annular projecting member 22a, the fixing hole 22b, a plurality of openings 22c and a plurality of slits 22d. The annular projecting member 22a is a projecting strip which has an annular shape and projects toward the edge 11a, so as to support the edge 11a. The fixing hole 22b receives the fixing member 41, so as to fix the fixing member 41. The fixing member 41 is inserted into each of the openings 22c. Each of the slits 22d has the function of allowing an acoustic wave radiated from the diaphragm 11 to be transmitted toward the upper surface of the third member 23.

The third member 23 is formed into a substantially cup-like shape, as viewed in cross section, and is interposed between the diaphragm 1 and the second member 22. The third member 23 has the function of allowing an acoustic wave radiated from the diaphragm 11 through each of the slits 22d to be radiated along the direction indicated by the arrow B, in the same direction as the sound output direction of the speaker unit 50 for reproducing low-frequency sound. Incidentally, for the sake of explanation, the arrow B is depicted only on a right side of the sheet in FIG. 1. However, in actual, the acoustic wave radiated from the diaphragm 11 of the speaker unit 51 for reproducing high-frequency sound is radially radiated through the plurality of slits 22d in the same direction as the sound output direction of the speaker unit 50 for reproducing low-frequency sound. Moreover, the third member 23 includes a plurality of openings 23a, into each of which the fixing member 41 is inserted.

The above-described first member 21, second member 22 and third member 23 are joined to each other as follows. At first, the second member 22 is joined to the speaker unit 51 for reproducing high-frequency sound via the fixing member or the like in the state in which the annular projecting member 22a abuts against the edge 11a. Next, the fixing member 41 is inserted into each of the openings 22c formed at the second member 22, so that the fixing member 41 is fitted into each of the fixing holes 21b formed at the first member 21. In this way, the second member 22 is joined to the first member 21, and therefore the speaker unit 51 for reproducing high-frequency sound is securely contained and fixed in a space defined between the first member 21 and the second member 22. Subsequently, the fixing member 41 is inserted into each of the openings 23a formed at the third member 23, and then the fixing member 41 is fitted into each of the fixing holes 21b formed at the joined first member 21. As a result, the first member 21, the second member 22 and the third member 23 are joined to each other in the state shown in FIG. 1.

The name plate 42 is made of a high polymer material, a metal material or the like, and is formed into a disk-like shape. Model information, manufacturer information and the like are printed on the name plate 42. Therefore, the name plate 42 has the function of notifying a user of such information. In addition, the name plate 42 is stuck to the recess 5e formed at the frame 5, thereby exhibiting the function of improving the appearance on the rear side of the speaker device 100.

As shown in FIG. 1, the coil 81 is disposed at the back surface of the grille 200, and further is interposed between the outer peripheral edge of the grille 200 and the annular projecting member 21a. Furthermore, in the state in which the grille 200 is attached to the frame 5, the coil 81 is located upward of the first flange portion 5a on the side of the first terminal 32a, as indicated by a broken line in FIG. 3. As described above, the coil 81 is connected in series to the second terminal 32b and the speaker unit 50 for reproducing low-frequency sound via the relay wire 71.

Although not shown in FIG. 1, the capacitor 82 is disposed at the back surface of the grille 200, like the coil 81, and further is interposed between the outer peripheral edge of the grille 200 and the annular projecting member 21a. Furthermore, in the state in which the grille 200 is attached to the frame 5, the capacitor 82 is located upward of the first flange portion 5a on the side of the second terminal 32b and the third terminal 32c, as indicated by the broken line in FIG. 3. As described above, the capacitor 82 is connected in series to the second terminal 32b and the speaker unit 51 for reproducing high-frequency sound via the other relay wire 70b.

In the above-described speaker device 100, the electric signals are input into the speaker unit 50 for reproducing low-frequency sound and the speaker unit 51 for reproducing high-frequency sound from the amplifier, so that the acoustic waves are radiated toward the sound output side, as illustrated.

Specifically, when an electric signal is input into the tinsel wire 9 from the amplifier side via the terminal unit 32, the relay wire 71 and the like in the speaker unit 50 for reproducing low-frequency sound, the electric signal is supplied to the voice coil 4. As a consequence, driving force is generated in the voice coil 4 inside of the magnetic gap 33, thereby vibrating the diaphragm 1 in the axial direction of the speaker unit 50 for reproducing low-frequency sound. In this manner, the speaker unit 50 for reproducing low-frequency sound radiates the acoustic wave on the sound output side, as illustrated. On the other hand, when an electric signal is input into the relay wire 70 or the like from the amplifier via the terminal unit 32 in the speaker unit 51 for reproducing high-frequency sound, the electric signal is supplied to the voice coil 14. As a consequence, driving force is generated in the voice coil 14 inside of the magnetic gap 34, thereby vibrating the diaphragm 11 in the axial direction of the speaker unit 51 for reproducing high-frequency sound. Thereafter, the acoustic wave radiated from the diaphragm 11 is transmitted through each of the slits 22d and reflected by the upper surface of the third member 23, and then is guided in the direction indicated by the arrow B. In this manner, the speaker unit 51 for reproducing high-frequency sound radiates the acoustic wave on the sound output side, as illustrated.

[Guide Structure]

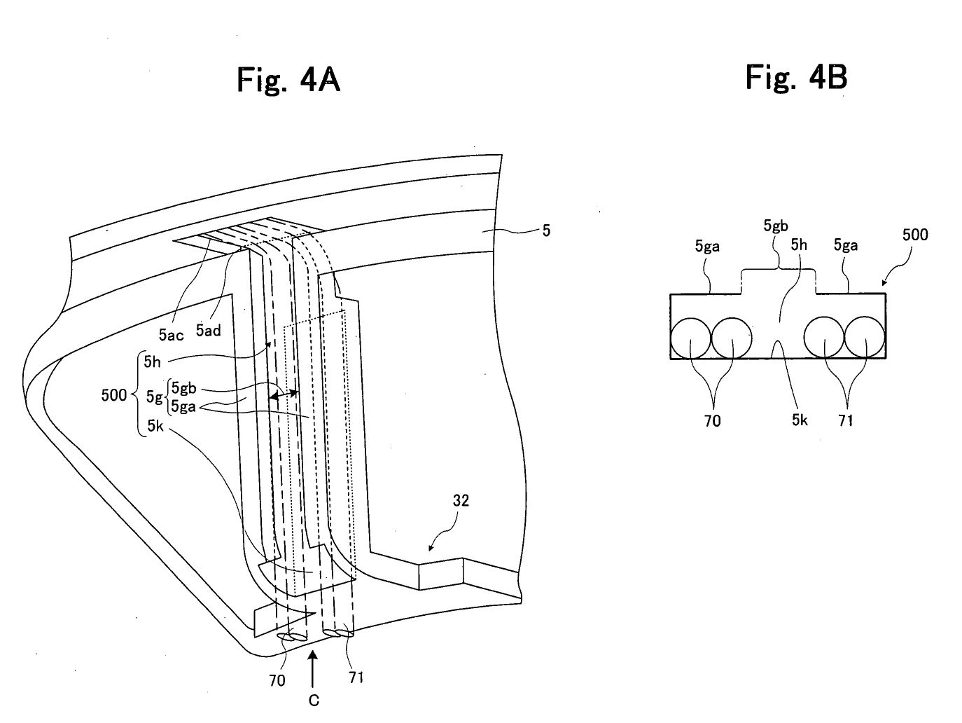

Subsequently, a detailed description will be given of the guide structure 500 provided in the frame 5 in reference to FIGS. 1 to 5. FIG. 4A is a perspective view showing the vicinity of the guide structure 500, as viewed slantwise from below. FIG. 4B is a back view showing the guide structure 500, as observed in a direction indicated by an arrow C in FIG. 4A.

The guide structure 500 has the functions of guiding the relay wire 70 drawn from the side of the voice coil 14 in the speaker unit 51 for reproducing high-frequency sound to the terminal unit 32a and of guiding the pair of relay wires 71 connected to both ends of the coil 80. The guide structure 500 is formed from the vicinity of the inner circumferential edge of the first flange portion 5a to the terminal unit 32, and is provided with a slit portion 5g and the wall 5k. The space 5h is defined between the slit portion 5g and the wall 5k.

As shown in FIGS. 2, 4A and 4B, the slit portion 5g includes a pair of slit walls 5ga. The slit walls 5ga are formed at positions opposite to each other. A gap 5gb is defined between the slit walls 5ga. Each of the slit walls 5ga has the function of guiding the relay wire 70 along the slit wall 5ga from the upper portion of the guide structure 500 to the lower portion of the guide structure 500. Furthermore, each of the slit walls 5ga has the function of guiding the relay wire 71 along the slit wall 5ga from the lower (or upper) portion of the guide structure 500 to the upper (or lower) portion of the guide structure 500. The gap 5gb is defined slightly thicker than each of the relay wires 70 and 71. Therefore, the relay wires 70 and 71 remain inside of the space 5h by styling the relay wires 70 and 71 on the rear side (namely, inside) of the gap 5gb and applying tension. In this manner, it is possible to prevent the relay wires 70 and 71 from projecting outside of the speaker device 100 or the like due to the vibration when the speaker device 100 is driven.

The space 5h is defined between the slit portion 5g and the wall 5k, and has the function of allowing the relay wire 70 to be inserted from the upper portion of the guide structure 500 to the lower portion of the guide structure 500. Moreover, the space 5h also has the function of allowing the relay wire 71 to be inserted from the lower (or upper) portion of the guide structure 500 to the upper (or lower) portion of the guide structure 500.

The wall 5k is formed at such a position as to face the slit portion 5g with the space 5h held therebetween, that is, on the center axis side of the speaker device 100. The wall 5k is a rectangular wall in substantially the same width as that of the slit portion 5g. Additionally, the wall 5k is formed in such a manner as to stand in the axial direction of the speaker device 100.

FIGS. 4A and 4B show the state in which the relay wires 70 and 71 are inserted into the guide structure 500 configured as described above. Here, alternate long and short dashed lines in FIGS. 4A and 4B indicate the relay wires 70 and 71.

As described above, in the guide structure 500 in the preferred embodiment according to the invention, the wall 5k is formed to stand on the center axis side of the speaker device 100. Therefore, even if variations occur in the styling of the relay wires 70 and 71 in the guide structure 500, the movement of the relay wires 70 and 71 is restricted by the wall 5k, so that the relay wires 70 and 71 can be prevented from being loosened or expanded from the position of the wall 5k toward the center axis side of the speaker device 100. Consequently, it is possible to effectively prevent the relay wires 70 and 71 from interfering with (namely, hitting against) the tinsel wire 9 in the speaker unit 50 for reproducing low-frequency sound, the diaphragm 1 or the like, due to the vibration caused by the driving when the speaker device 100 is driven. Thus, it is possible to omit a special process of preventing the interference of the relay wires 70 and 71 in the guide structure 500 in fabricating the speaker device 100. Incidentally, the guide structure 500 can be formed at the frame 5 at the same time as the fabrication of the frame 5. As a result, the fabrication of the guide structure 500 cannot induce any increase in product cost of the frame 5 or the like.

1. A speaker device comprising:
a speaker unit;
a wire drawn from a voice coil of the speaker unit; and
guide structure for guiding the wire;
wherein the guide structure includes a wall standing on a side of the speaker unit, and wherein the wire is guided along the wall on a side opposite to the speaker unit.

2. The speaker device according to claim 1, further comprising:
another speaker unit; and
a grille disposed on a sound output side of the other speaker unit;
wherein the speaker unit is arranged coaxially with and above the other speaker unit, and wherein the speaker unit is fixed to the grille in a state in which a sound output side of the speaker unit faces the sound output side of the other speaker unit.

3. The speaker device according to claim 2, wherein the guide structure is formed at a frame of the other speaker unit which is disposed below the speaker unit.

4. The speaker device according to claim 3, wherein the frame includes a flange portion which is fitted to a peripheral edge of the grille, and wherein the flange portion includes:
a through hole into which the wire drawn from the voice coil is inserted;
a recess which communicates with the through hole and guides the wire inserted into the through hole toward the guide structure; and
an opening which communicates with the recess and the guide structure, and guides the wire guided by the recess to the guide structure.

5. The speaker device according to claim 4, further comprising a terminal unit between the guide structure and an upper end on an outer peripheral wall of the frame,
wherein the guide structure is formed from a vicinity of an inner circumferential edge of the flange portion to the terminal unit.

6. The speaker device according to claim 3, wherein the wire is guided between the outer peripheral wall of the frame and the wall.

7. The speaker device according to claim 3, wherein the frame is made of a resin material.

8. The speaker device according to claim 1, wherein the guide structure includes a slit portion formed from an upper portion of the guide structure to a lower portion of the guide structure, and wherein a space to receive the wire is defined between the slit portion and the wall.
